(19) United States
(12) Patent Application Publication
(10) Pub. No.: US 2025/0137428 A1
(43) Pub. Date: May 1, 2025

(54) Cellular And/Or Bladed Wheel Assembly

(71) Applicant: ActioEvent GmbH, Berlin (DE)

(72) Inventor: Florian Kossin, Berlin (DE)

(73) Assignee: ActioEvent GmbH, Berlin (DE)

(21) Appl. No.: 18/578,501

(22) PCT Filed: Jul. 12, 2022
(86) PCT No.: PCT/EP2022/069106

§ 371 Date: Jan. 11, 2024

(30) Foreign Application Priority Data
Jul. 12, 2021 (DE) 10 2021 117 952.1

(51) Int. Cl. F03B 7/00; F03B 11/02

(52) U.S. Cl. CPC F03B 7/00; F03B 11/02; F05B 2250/311

(57) ABSTRACT

The present invention relates to a cellular and/or bladed wheel assembly, comprising a first cellular and/or bladed wheel and a second cellular and/or bladed wheel, the first cellular and/or bladed wheel and the second cellular and/or bladed wheel being connected to one another for conjoint rotation and about a common 5 axis of rotation.

The present invention relates to a cellular and/or bladed wheel assembly, as well as the use of such an assembly in a hydropower machine assembly.

Cellular and/or bladed wheels are generally known. They consist essentially of a wheel-like main body which is arranged about an axis of rotation and has radially circumferentially a plurality of cells, blades or the like, by means of which a medium, for example water, is transported.

Cellular and/or bladed wheel assemblies, such as water wheels, may be for example components of hydropower machines for converting potential energy into kinetic energy. This kinetic energy can then be used for example to generate electrical energy by means of an electric generator.

A disadvantage of previously known cellular and/or bladed wheels is their simple design, which only allows a single purpose. For example, by means of known cellular and/or bladed wheels it is only possible for a medium to be transported in one flow and/or in one direction.

The object of the present invention is therefore to address one of the aforementioned problems. Alternatively, it is intended that the general state of the art should be improved. At least, however, it is intended that an alternative to what is known so far should be provided.

According to the invention, a cellular and/or bladed wheel assembly is thus proposed.

The cellular and/or bladed wheel assembly here comprises at least a first cellular and/or bladed wheel and a second cellular and/or bladed wheel, which are connected to one another for conjoint rotation and about a common axis of rotation.

The cellular and/or bladed wheel assembly may for example also be designed as in the case of an undershot water wheel. Preferably, the cellular and/or bladed wheel assembly is at least partially enclosed at the side, for example over at least 20 percent of its area.

A cellular or bladed wheel should be understood here as meaning in particular wheel-like constructions which have a finite number of blades and/or cells or the like which are arranged circumferentially, such as in particular in the case of water wheels.

In a preferred embodiment, the cellular and/or bladed wheel assembly is designed as a cellular wheel assembly. The wheels therefore have cells that are set up for a specific medium transport. The size and shape of the cells is preferably determined by the medium to be transported or moved.

In a further preferred embodiment, the cellular and/or bladed wheels are arranged concentrically in relation to one another and about an axis of rotation.

The first cellular and/or bladed wheel comprises for example eight cells and the second cellular and/or bladed wheel comprises for example four cells, each of which is preferably designed in the same way.

The cellular and/or bladed wheels therefore preferably each have similar cells, but an unequal number of cells to one another. The cellular and/or bladed wheels may also have cells different to one another. Preferably, the cells of the cellular and/or bladed wheels are formed in relation to one another in such a way that the cellular and/or bladed wheels each transport the same volume.

The size, i.e. the volumetric capacity, of the cells and/or blades can be freely selected, taking into account the intended use of the cellular and/or bladed wheel assembly.

The cellular and/or bladed wheel assembly may also have more than two cellular and/or bladed wheels, for example three or four cellular and/or bladed wheels.

Furthermore, the cellular and/or bladed wheels may also be adjacent to one another or may be kept at a distance from one another, for example by more than 0.5 m.

Preferably, the first cellular and/or bladed wheel has a first diameter and the second cellular and/or bladed wheel has a second diameter, the first diameter being greater than the second diameter.

The first cellular and/or bladed wheel is therefore made larger than the second cellular and/or bladed wheel.

For example, the first cellular and/or bladed wheel has a diameter of more than 2 m, in particular more than 10 m, preferably about 15 m, and the second cellular and/or bladed wheel has a diameter of more than 1 m, in particular more than 2 m, preferably about 7.5 m.

In a preferred embodiment, the diameter of the first cellular and/or bladed wheel is approximately twice as large as the diameter of the second cellular and/or bladed wheel.

Preferably, the cellular and/or bladed wheels are designed differently, for example in width, height and length. If the cellular and/or bladed wheels are designed differently, for example if one wheel is larger than another, the cells of the wheels are designed in such a way that the wheels transport the same volume.

In a preferred embodiment, the first cellular and/or bladed wheel and the second cellular and/or bladed wheel also have essentially the same width.

Preferably, the first cellular and/or bladed wheel and/or the second cellular and/or bladed wheel is mainly made of wood and/or metal and/or plastic.

The cellular and/or bladed wheel is for example mainly produced from wood or welded from steel or molded from plastic.

The material and/or the processing of the cellular and/or bladed wheel are preferably carried out in such a way that the cellular and/or bladed wheel is designed as water-resistant-that is to say can be used non-destructively when subjected to water. This can be achieved for example by the wood being processed appropriately or stainless steel being used.

Preferably, a cell or a blade of the first cellular and/or bladed wheel and/or the second cellular and/or bladed wheel has at least a volumetric capacity of 10 liters.

The cellular and/or bladed wheel is therefore of a size that also allows an economical industrial application.

In a preferred embodiment, the volumetric capacity is between 100 liters and 1000 liters per cell.

Preferably, the first cellular and/or bladed wheel has more or fewer cells or blades than the second cellular and/or bladed wheel.

Consequently, the bladed wheels are in particular not identical.

Preferably, the first cellular and/or bladed wheel has at least 24 cells or blades.

Preferably, the second cellular and/or bladed wheel has at least 12 cells or blades.

Also proposed according to the invention is a (hydropower) machine assembly, at least comprising a cellular and/or bladed wheel assembly described above or below and a mechanical shaft and optionally an electric generator.

The mechanical shaft can then be used for example as a means for driving a generator to convert energy or another device, such as for example a mill.

The mechanical shaft preferably connects the cellular and/or bladed wheel to an electric generator in such a way that the cellular and/or bladed wheel assembly drives the electric generator to generate electrical energy.

So if the cellular and/or bladed wheel assembly is operated with a medium, such as for example water, as in the case of a water wheel, the rotational movement thereby produced can be transmitted by means of the shaft to the generator, which generates electrical energy from the rotational movement.

But other application examples, such as mills or hoists, which use mechanical energy directly, i.e. do not convert the mechanical energy on the shaft into electrical energy like a generator, are also conceivable.

Preferably, the hydropower machine assembly also comprises a first supply or discharge line and/or a second supply line, which are designed in particular as fluid-conducting and/or fluid-tight.

Preferably, the second supply or discharge line is arranged below the first supply or discharge line.

The supply or discharge lines may for example be designed as a hose, in particular made of plastic, or as a ditch in the ground, for example in the form of a channel. But a pipe or a lake or similar could also be used for this purpose.

Optionally, the hydropower machine assembly also has an electrical accumulator, an expansion tank and/or a housing.

Preferably, the electrical accumulator is connected to the electric generator in order to store the electrical energy generated by the generator.

Preferably, the expansion tank is set up to provide excess medium in the hydropower machine assembly and/or an essentially constant volume of medium in the hydropower machine assembly.

Preferably, the housing is set up to close off the cellular and/or bladed wheel assembly in a medium-tight manner in such a way that the medium essentially circulates within the hydropower machine assembly between the first cellular and/or bladed wheel and the second cellular and/or bladed wheel.

According to the invention, the use of a cellular and/or bladed wheel assembly described above or below in a hydropower machine for the production of energy, in particular electrical energy, is proposed.

The present invention is explained in more detail below by way of example and on the basis of the accompanying figures, with the same reference signs having been used for the same or similar modules.

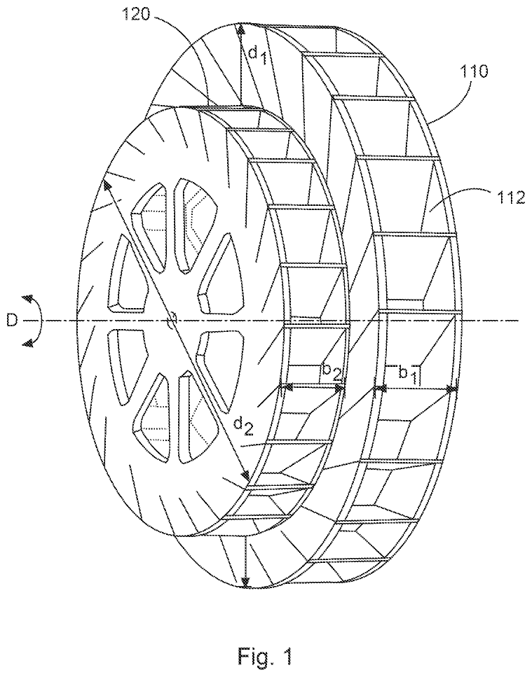

FIG. 1 shows a cellular wheel assembly in a perspective view.

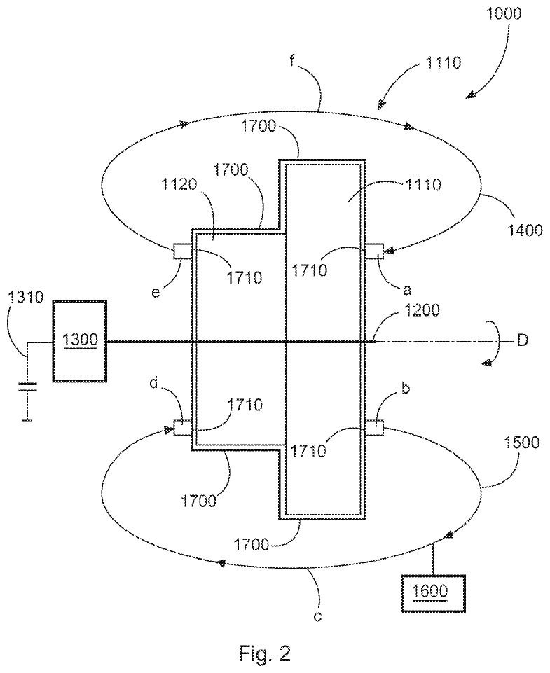

FIG. 2 shows a hydropower machine assembly in a side view.

FIG. 1 shows a cellular wheel assembly 100.

The cellular wheel assembly 100 comprises a first cellular wheel 110 and a second cellular wheel 120, the first cellular wheel 110 and the second cellular wheel 120 being connected to one another for conjoint rotation and about a common axis of rotation D.

The first cellular wheel 110 and the second cellular wheel 120 are also arranged concentrically in relation to one another and about the axis of rotation D. The second cellular wheel 120 is arranged in particular in the middle of the first cellular wheel 110.

The first cellular wheel 110 is also made larger than the second cellular wheel 120. This is achieved in particular by the first cellular wheel having a diameter d1, which is greater than the diameter d2 of the second cellular wheel. The width b1, b2 of the cellular wheels is preferably essentially the same. For example, a cell 112 of the first cellular wheel has a volume of 100 liters.

Preferably, the cellular wheel assembly 100 is produced from stainless steel. This also means in particular that the first cellular wheel 110 and the second cellular wheel 120 are produced from the same material.

FIG. 2 shows a hydropower machine assembly 1000 in a side view.

The hydropower machine assembly 1000 comprises a cellular wheel assembly 1100, as shown for example in FIG. 1, a mechanical shaft 1200 and a generator 1300.

The cellular wheel assembly thus comprises at least a first cellular wheel 1110 and a second cellular wheel 1120, which are rotatably mounted for conjoint rotation about a common axis of rotation D.

The mechanical shaft 1200 is also arranged in this axis of rotation.

The mechanical shaft 1200 connects the cellular wheel assembly 1100 to the electric generator 1300, in particular such that the cellular wheel assembly 1100 can drive the electric generator 1300 to generate electrical energy.

In order to set the cellular wheel assembly 1100 in a rotational movement, the hydropower machine assembly 1000 has a first supply line 1400 and a second supply line 1500, the second supply line 1500 being arranged below the first supply line 1400.

The supply lines 1400, 1500 lead out of the cellular wheel assembly horizontally, for example.

The supply lines 1400, 1500 can be used to charge or fill the first or the second cellular wheel 1110, 1120—according to requirements—with a medium, for example water. The force of the weight of the medium and the rotatable mounting of the cellular wheels 1110, 1120 cause the cellular wheel assembly 1100 to be set in a rotational movement, which is transferred by means of the shaft 1200 to the generator 1300, which forms electrical energy from the kinetic energy of the rotational movement. The energy thus generated by the generator 1300 can then be fed directly into an electrical network or stored in an electrical accumulator 1310.

The supply lines 1400, 1500 are preferably connected to the cellular wheels 1110, 1120 in such a way as to obtain a closed circuit (a′, b′, c′, d′, e′, f′), on which an expansion tank 1600 is optionally arranged. To form this circuit (a′, b′, c′, d′, e′, f′), composed of the cellular wheels 1110, 1120 and the supply lines 1400, 1500, a housing 1700, which in particular covers or closes off the cellular wheels 1110, 1120, may also be provided.

If a housing 1700 is provided, it has openings which are connected to the supply lines. In a further embodiment, the cellular wheels 1110, 1120 may also additionally have lateral openings to receive the medium.

Preferably, the supply lines 1400, 1500 are also arranged such that the medium moves within the first cellular wheel 1110 from the top downward (a′->b′), from there flows via the second supply line 1500 to the second cellular wheel 1120 (b′->c′->d′), moves within the second cellular wheel 1120 from the bottom upward (d′->e′) and from there flows via the first supply line 1400 back again in a closed circuit (a′, b′, c′, d′, e′, f′) to the first cellular wheel 1100 (e′->f′->a′).

The cellular wheel assembly 1100 is also designed and mounted such that the movement of the medium from the bottom upward in the second cellular wheel 1120 (d′->e′) is caused by the movement of the medium from the top downward in the first cellular wheel 1110 (a′->b′).

In a preferred embodiment, the supply lines 1400, 1500 may also be designed as a channel in the ground, for example a->e or b->d.

In a further embodiment, e is arranged above a and b above d. The supply lines 1400, 1500 are thus arranged such that the medium only flows through the supply line driven by the force of its weight.

The cellular and/or bladed wheel assembly in the power machine may also have more than two cellular and/or bladed wheels.

### LIST OF REFERENCE SIGNS

100 Cellular and/or bladed wheel assembly
110 First cellular and/or bladed wheel
112 Cell, in particular of the first cellular and/or bladed wheel
120 Second cellular and/or bladed wheel
1000 Hydropower machine assembly
1100 Cellular and/or bladed wheel assembly
1110 First cellular wheel
1200 Mechanical shaft
1300 Electric generator
1310 Electrical accumulator
1400 First supply line
1500 Second supply line
1600 Expansion tank
1700 Housing
D Axis of rotation
d1 Diameter of the first cellular and/or bladed wheel
d1 Diameter of the second cellular and/or bladed wheel
b1 Width of the first cellular and/or bladed wheel
b2 Width of the second cellular and/or bladed wheel
a′, b′, . . . . Points of a circuit

1. A cellular and/or bladed wheel assembly (100), comprising:
a first cellular and/or bladed wheel (110); and
a second cellular and/or bladed wheel (120),
the first cellular and/or bladed wheel (110) and the second cellular and/or bladed wheel (120) being connected to one another for conjoint rotation and about a common axis of rotation (D).

2. The cellular and/or bladed wheel assembly (100) as claimed in claim 1,
the first cellular and/or bladed wheel (110) having a first diameter (d1) and
the second cellular and/or bladed wheel (120) having a second diameter (d2),
the first diameter (d1) being greater than the second diameter (d2).

3. The cellular and/or bladed wheel assembly (100) as claimed in claim 1,
the first cellular and/or bladed wheel (110) and/or the second cellular and/or bladed wheel (120) being mainly made of a material of the following list consisting of:
wood;
metal, in particular steel;
plastic.

4. The cellular and/or bladed wheel assembly (100) as claimed in claim 1,
a cell (112) or a blade of the first cellular and/or bladed wheel (110) and/or the second cellular and/or bladed wheel (120) having at least a volumetric capacity of 10 liters.

5. The cellular and/or bladed wheel assembly (100) as claimed in claim 1,
the first cellular and/or bladed wheel (110) having more or fewer cells (112) or blades than the second cellular and/or bladed wheel (120), in particular
the first cellular and/or bladed wheel (110) having at least 4, preferably at least 8, more preferably at least 24 cells (112) or blades and/or
the second cellular and/or bladed wheel (120) having at least 2, preferably at least 4, more preferably at least 12 cells or blades.

6. A (hydropower) machine assembly (1000), comprising:
a rotatably mounted cellular and/or bladed wheel assembly (100, 1100) as claimed in claim 1 and
a mechanical shaft (1200) and
optionally: an electric generator (1300), with
in particular the mechanical shaft (1200) connecting the cellular and/or bladed wheel assembly (1100) to the electric generator (1300) in such a way that the cellular and/or bladed wheel assembly (1100) drives the electric generator (1300) to generate electrical energy.

7. The hydropower machine assembly (1000) as claimed in claim 6, also comprising:
a first supply or discharge line (1400), in particular to set the cellular and/or bladed wheel assembly (1100) in a rotational movement, which
is set up to carry a medium; and/or
connects the first cellular and/or bladed wheel (110) to the second cellular and/or bladed wheel (120) in a medium-conducting manner.

8. The hydropower machine assembly (1000) as claimed in claim 7, also comprising:
a second supply or discharge line (1500), in particular to set the cellular and/or bladed wheel assembly (1100) in a rotational movement, which
is set up to carry a medium; and/or
connects the second cellular and/or bladed wheel (120) to the first cellular and/or bladed wheel (110) in a medium-conducting manner, the second supply line (1500) being arranged below the first supply line (1400).

9. The hydropower machine assembly (1000) as claimed in claim 6, also comprising:
an electrical accumulator (1310), which is connected to the electric generator (1300) to store the electrical energy generated by the generator (1300);
optionally: an expansion tank (1600), which is set up to provide an essentially constant volume of medium in the hydropower machine assembly (1000);
optionally: a housing which closes off the cellular and/or bladed wheel assembly in a medium-tight manner in such a way that the medium essentially circulates within the hydropower machine assembly (1000) between the first cellular and/or bladed wheel and the second cellular and/or bladed wheel.

10. The use of a cellular and/or bladed wheel assembly (1100) as claimed in claim 1 in a hydropower machine for the production of energy, in particular electrical energy.
